(19) United States
(12) Patent Application Publication
(10) Pub. No.: US 2015/0179085 A1
(43) Pub. Date: Jun. 25, 2015

(54) Interactive Method and Game For Learning Characters and Spelling of a Foreign Language

(71) Applicant: Kenneth G. Ruyter, Gaithersburg, MD (US)

(72) Inventor: Kenneth G. Ruyter, Gaithersburg, MD (US)

(21) Appl. No.: 14/576,133

(22) Filed: Dec. 18, 2014

Related U.S. Application Data
(60) Provisional application No. 61/919,633, filed on Dec. 20, 2013.

(51) Int. Cl. G09B 19/06

(52) U.S. Cl. CPC G09B 19/06

(57) ABSTRACT

The present invention is directed to a method for learning a foreign language using a computer game and to an interactive spelling and speech learning system comprising the game and computer system on which the game is run.

### CROSS REFERENCE TO RELATED APPLICATIONS

The present application claims the benefit of U.S. provisional application 61/919,633, filed on Dec. 20, 2013, the contents of which is hereby incorporated by reference in its entirety.

### FIELD OF THE INVENTION

The present invention is in the field of computer-aided education, particularly with respect to languages.

### BACKGROUND OF THE INVENTION

Several language-learning methods exist that use transliteration or immersion techniques to teach proper phonics and spelling. However certain languages, e.g. tonal languages, contain hundreds of characters that make learning by these techniques difficult. There is a need for a method, which specializes in teaching users to identify the appearance and sound of characters more efficiently for these languages.

### SUMMARY OF THE INVENTION

The present invention is directed to a learning method that uses a subset of a language's characters to teach the relationship between the characters and the sound and meaning of words or phrases in which they are used. Characters are displayed in a way that allows the user to understand the languages' construction, while user attention is maintained by means of an animated game that provides the user with a series of problems of increasing complexity. Animations may be stationary or create the effect of objects passing by and, in either case, the user must respond by dragging the correct character on to the passing object in the time allowed. Audio from a male and/or female speaker is provided to teach the user the sound of words or characters selected as well as the meaning of words and phrases. Exposure to the sounds of correct responses to each problem provided in the game, combined with visual exposure to the components comprising the response teach users to correlate these elements. Also, by requiring that a user choose between multiple characters, the user is taught to differentiate these characters.

### BRIEF DESCRIPTION OF THE DRAWINGS

FIG. 1 is a view of the computer application displaying a challenge.

FIG. 2 shows the act of dragging a character object into the problem solving area.

FIG. 3 shows an additional character drag with an expanded background in the problem solving area.

FIG. 4 depicts the solved challenge and how two separate characters were merged into one character with a diacritical mark;

FIG. 5 depicts the solution to the challenge as it is displayed in the user's character area.

### DETAILED DESCRIPTION OF THE INVENTION

The invention is directed to a method that teaches a user the various characters and sounds in a language. The invention also includes a computer program that runs the method and which is part of a system comprising a database, a computer program, a graphical user interface, and a delivery and timing scheme for the data. The database provides data to the computer program, which works in tandem with the graphic user interface and timing scheme.

The Database contains a set of problems that the user will be exposed to while using the computer program. The computer program displays the data in a specified sequence and the graphical user interface interacts with the user to provide the learning experience. The timing scheme manages how the elements work together temporally.

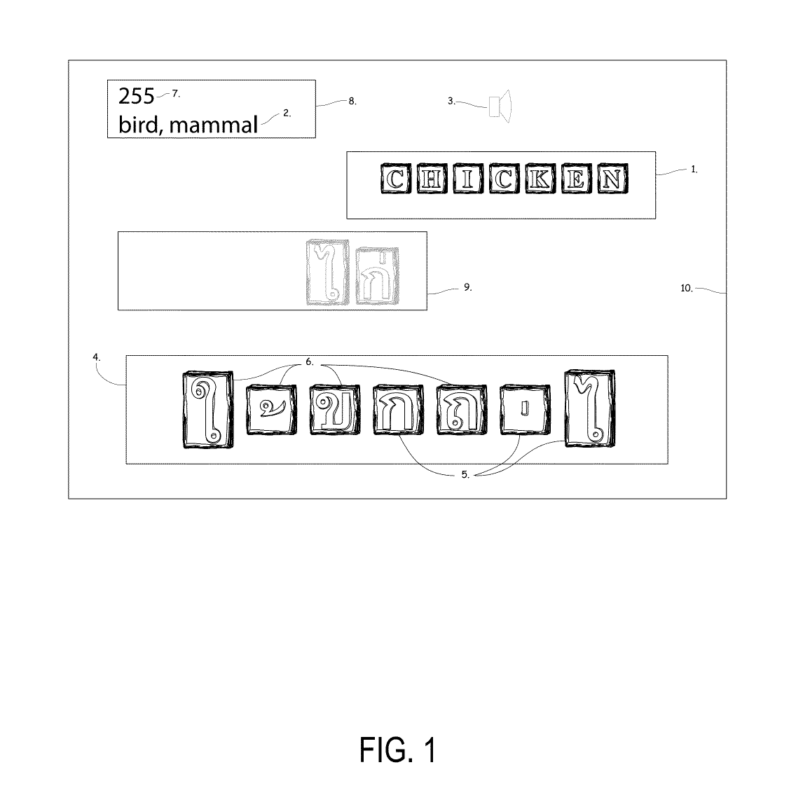

In a preferred embodiment, the computer program presents itself to the user like a book, in that there are chapters, and subsections. Each subsection contains individual challenges. A subsection's group of challenges comprises the learning material, whose source is the database. The challenges and pedagogy of the method are managed by the computer program, which sets run-time program attributes including, but not limited to the characters to be used as “noise,” the amount of points a user must score to “pass,” the speed and order of the material that will be displayed, and the state of various program settings, including visible characters, enforcement of solution input order, on/off state of audio clues, and overall speed setting. The computer program creates an array of challenges for the subsection, and the graphical user interface FIGS. 1-5 iterates through it. Further, the challenge contains both a prompt and a context, i.e., a reason for its presentation leading to an expected response on the part of the user. For example, if the prompt is a given word, the context may be to identify the meaning of that word.

As seen in FIG. 1, each challenge may include: (a) presentation of a textual or audio element in a first language, e.g., the native (“source”) language of the user, displayed in a challenge area (1), (b) a given context (2), (c) an audio sample of the solution in a second, “learned” language (the language to be learned) - annunciated via the device's speakers (3), and (d) a selection area to contain the user's characters (4) that comprise the solution (5), jumbled together with additional “noise” characters integrated which are not part of the solution (6). The score (7) is displayed, in a score keeping area (8), tiles will be dragged to the test area (9), which FIG. 1 depicts as grayed, reflecting a current state of not being visible. The game window (10), represents the area as displayed in a computer screen. In the example shown in FIG. 1, the source language is English and the learned language is Thai. It should be noted that the method is designed to work between any source language and any learned language.

Further, data may be displayed regarding an individual character or combination of characters, e.g., in Thai, all consonants have a class: low, middle or high. When the user selects a character, data representing it's consonant class may be displayed. All Thai words are spoken with a specific tone, and a representation of that tone may be displayed. Additionally, the character depiction, e.g., the tile, may contain color or shape variations to reveal different information about the character to be presented to the user as a memorization aid.

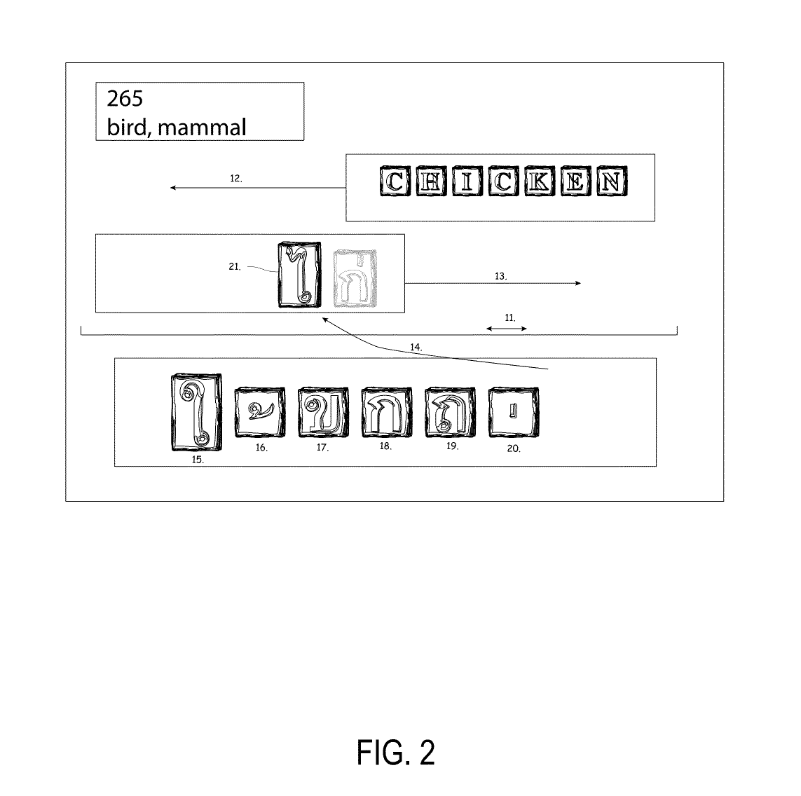

As depicted in FIG. 2, in order to keep the user engaged with the computer program, a set window of time (11) may be available for the user to work on solving the challenge. The computer program may determine the window of time based on a preset specification or by analyzing the users skill level and/or current performance. Item (11), represents the depiction of time, specifically the duration in which the user may drag characters from the challenge area. During this period, the clue, selection and test areas may animate themselves. For example, a passing object presenting in the test area may move from one side of the screen to the other while the challenge may move in an opposite manner from the opposite direction, as illustrated by the arrows in (12) and (13), during the duration represented by (11). The specific direction of movement is not critical. For example, if Japanese characters were used, the characters would logically move in a vertical direction.

In order to correctly respond to the challenge, the user must “drag” a character from the challenge area onto the test area within the determined time specification (11), as depicted by the action of (14). When any character in the selection area is selected, its name, or natural sounding representation of the character, is annunciated with either a male or female voice via the device's speaker. If the character is the correct, it will appear in the test area while being removed from the selection area. Otherwise, the character will automatically revert back to the selection area.

A given challenge may require that the characters be dragged in sequence. For instance, the proper sequence for the example shown in FIG. 2 is (21), (18) and then (20). Any other, incorrectly dragged character (15, 16, 17, 19) will result in an error sound played through the speakers and the selected character will return to the user area. This may optionally result in a loss of points. Additionally, the exercises provided by the program may provide for “character giveaways”. For example, the challenge may start with a letter already visible in the test area, in order to provide the user with a clue to the correct solution, the rest of which must be provided by the user.

Typically, when a user drags a correct character onto the test area, a score will be assessed, and the score keeping area will be updated. When the user passes a preset amount of points they will be considered to have passed that subsection of the game.

In further detail, the computer software analyzes the characters and determines “noise” characters in order to create challenges, by determining similarities of different characters. This presentation teaches the user to think about the differences between characters. Characters can look similar, can sound similar, or be used in ways that substantiate a need to know a difference between them. The “noise” characters are displayed with the solution, in the selection area, in a jumbled fashion in order to make the user think about these differences. In a given language, syllables may include diacritical marks, tone marks, vowels, and other elements or rules that change it's sound. These can be difficult to memorize en masse and the present teaching method therefore provides a more manageable reduced set of characters, i.e., the user is purposefully given a very limited set which contains the correct answer and specific “noise” characters.

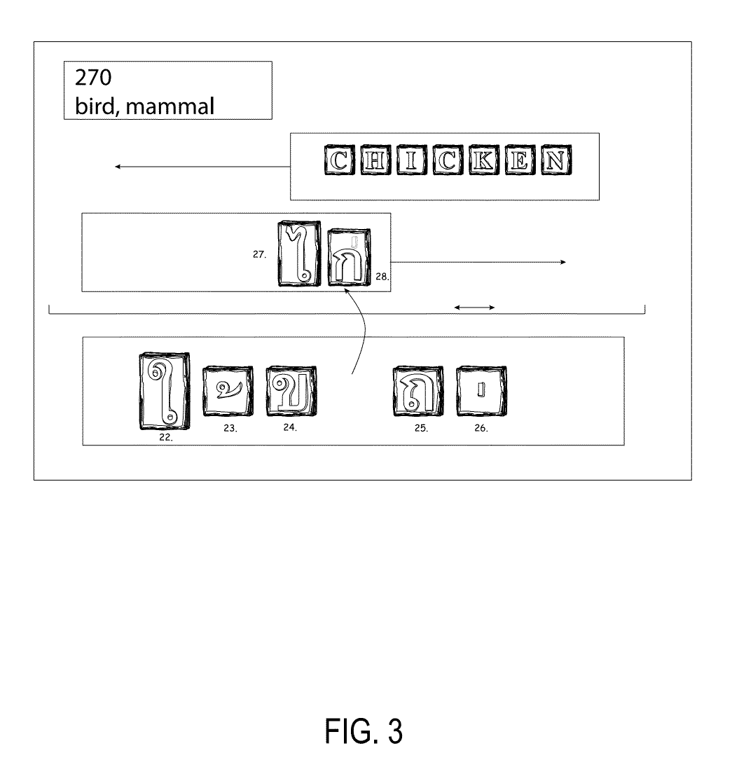

In FIG. 3, there are several characters (22-26) in the selection area. These represent characters chosen by the computer program based upon their relationship to one another. In the example shown, item 22 is related to item 27 in that they sound the same and also have a similar, but slightly different appearance. There is also a relationship between item 23 and item 26, because they are both commonly used tone marks and errors commonly occur when spelling words using these, and items 25 and 28 have a similar look, although they do not sound similar. By specifically examining differences of these types, the user becomes more astute at the different characters of the language they are studying.

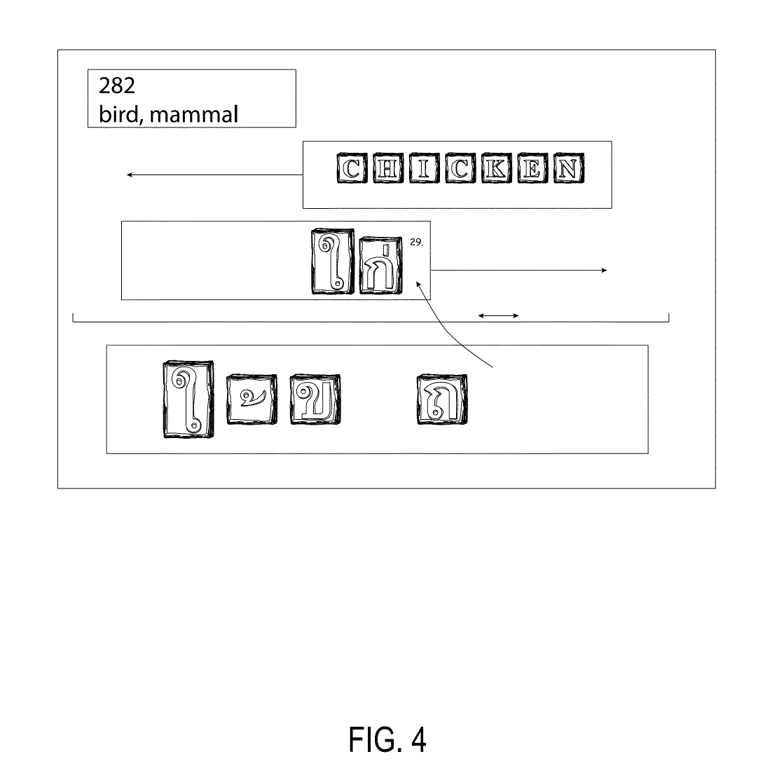

In certain languages, a letter character may be merged with an accent or other diacritical mark to create a new character e.g., “accent grave,” in French where the diacritic is added to a given character such as: “ù” or as combined to form a new character such as in niña in Spanish: “ñ.” A characteristic of the computer program used in the present method is that it automatically combines symbols and their associated tiles in this manner. For example, in FIG. 4, a final piece (FIG. 3.26), a diacritic mark, is dragged onto the passing object—after which it is automatically merged with the previously solved character (FIG. 2.18), to create a tile that contains both the character and its diacritic mark. Additionally, vowels that attach themselves to a consonant may be displayed and merged in this manner. The size of the background of the original character may be changed to handle displaying the character merged with the diacritical mark as one object. Objects, which can be merged, may appear before, above, below, on top of or after an initial object, or in any combination thereof. The computer program manages the display and merging of any, including multiple objects that need to be merged.

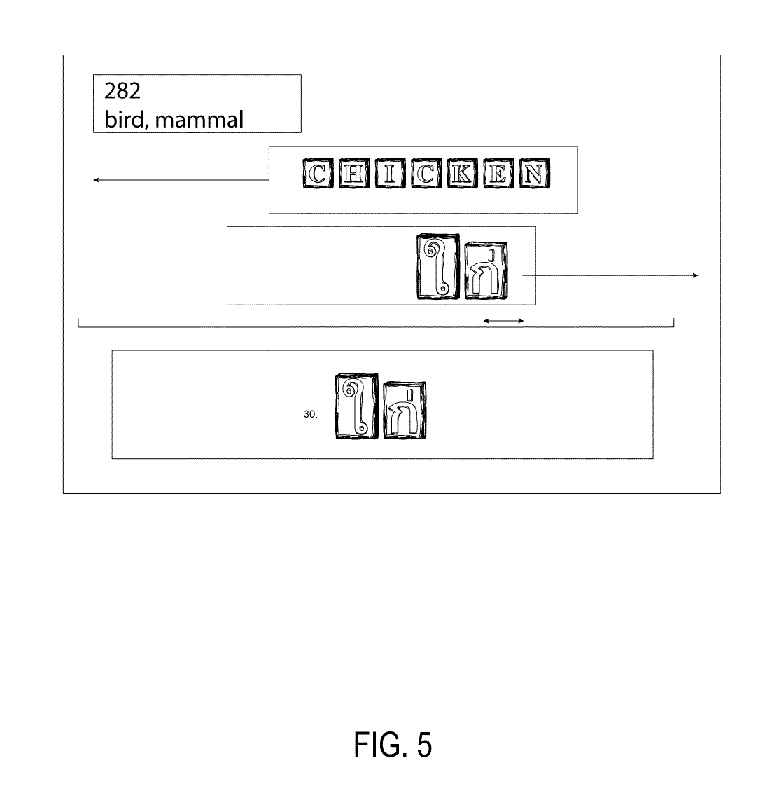

Finally, (FIG. 5) if the user finishes a challenge or if the user runs out of time, the user's characters are removed and the solution (30) is displayed in the selection area. At this point the computer program may repeat the pronunciation of the challenge through the device's speaker. After a short period, the next challenge appears and repeats this process for the entire subsection. After a predetermined set of challenges has been displayed, the computer program assesses the user's score and determines if the user may then proceed to the next level.

Repetitively exposing the user to the sounds of the characters along with the challenges helps the memorization process. It ultimately teaches the user to “think” in a language instead of using a transliteration process to determine the meaning of words. As discussed above, it is generally preferred that the method be implemented by means of a computer program teaching a user the differences between the characters present in a given language. However, some, or all aspects of the method may be implemented by other means such as a board game or electronic device.

The method disclosed herein should provide a better and more effective user experience than other methods that are not interactive at the character level and allows a user to be exposed to similarities and differences between characters in a targeted way. The method allows users to build vocabulary and relate spoken words to the way that they are represented in writing. The method is of particular value in teaching languages that have many characters and/or that rely heavily on diacritic marks in writing.

The following is a nonlimiting list of some of the concepts described herein:
¶1. A computer program which encodes a game for learning a foreign language, wherein said computer program comprises a graphic user interface (GUI) and provides for:
   a) the playback of sounds, the handling of user input, and the retrieval and modification of local program data;
   b) the presentation of different subjects and levels of difficulty;
   c) the management of GUI animations in a timed, sequential manner; and
   d) the scoring and monitoring of the skill level of a user;

wherein said GUI comprises:
i) a test area which displays text generated by the CPU and which serves to prompt a user for a response;
ii) a selection area in which characters or symbols are displayed that may be selected by a user;
iii) a response area in which characters selected by the user from the selection area may be placed;
and wherein the movement of characters or symbols by the user from the selection area to the response area will result in the awarding of points to the score of the user if the characters or symbols moved match a set of tiles predetermined by the CPU.
¶2. The computer program of paragraph 1, wherein said GUI further comprises:
   a) a challenge area which describes the problem to be solved by the user;
   b) an information area, which contains special symbols that depict specific notes about challenge word or solution;
   c) a score area that displays the score of the user.
¶3. The computer program of paragraph 1, wherein, when in operation, said computer program:
   a) generates a first set of tiles in said test area which contain various characters of a “foreign language;”
   b) generates a second set of said tiles in a “native language” in said selection area wherein some of the tiles in said second set are “solution tiles” that will result in the addition of points to the score of said user if moved to the response area and other tiles “noise tiles” that will not result in points if moved to the response area and wherein said native language is different from said foreign language.
¶4. The computer program of paragraph 3, wherein the user selects a tile by using a mouse or touch interface to click on the tile in the selection area and then dragging the tile to the response area.
¶5. The computer program of paragraph 4, wherein said GUI further comprises animated objects and characters.
¶6. The computer program of paragraph 4, wherein said computer program provides for the movement, rotation, and visibility of the areas where tiles appear and are dragged and the area where the solution appears.
¶7. The computer program of paragraph 4, wherein, in response to the selection of a tile by the user, the CPU generates a sound corresponding to the pronunciation of the character on the tile selected.
¶8. The computer program of paragraph 7, wherein solution tiles and noise tiles are chosen by the CPU based upon a likelihood that they will be confused with one another due to similarity in the pronunciation or the appearance of the characters.
¶9. The computer program of paragraph 7, wherein no more than 20 tiles are generated in the selection area by the CPU.
¶10. The computer program of any one of paragraphs 1-9, wherein the CPU generates an audio sample of the characters or symbols which will together result in the awarding of points if selected by the user.
¶11. The computer program of any one of paragraphs 1-9, wherein the CPU generates an audio sample of the characters or symbols which will together result in the awarding of points if selected by the user at the end of each challenge.
¶12. The computer program of any one of paragraphs 1-9, wherein a tile containing a character and a tile containing a diacritical may combine when moved from the selection area to the response area thereby forming a single tile containing both the character and diacritical symbol.
¶13. The computer program of paragraph 12, wherein, when the tile formed by the combination of tile with a character and a tile with a diacritical symbol assumes a size or shape that is different from either of the tiles combined.
¶14. The computer program of any one of paragraphs 1-9, wherein said computer program allows a user to turn off audio playback of characters.
¶15. The computer program of any one of paragraphs 1-9, wherein said computer program allows said user to pause and resume the game.
¶16. The computer program of any one of paragraphs 1-9, wherein said computer program allows for access to the internet.
¶17. The computer program of any one of paragraphs 1-9, wherein internet access may be used to change datasets of characters and symbols.
¶18. The computer program of any one of paragraphs 1-9, wherein internet access allows access to a language teacher to augment the teaching of said foreign language.
¶19. The computer program of paragraph 12 or 13, wherein said foreign language is Thai and said native language is English.
¶20. The computer program of paragraph 12 or 13, wherein said foreign language is English and said native language is Thai.
¶21. The computer program of any one of paragraphs 1-9, wherein examples of said challenges are provided with a male or a female voice.
¶22. The computer program of any one of paragraphs 1-9, wherein examples of said challenges are provided with both male and female voice.
¶23. The computer program of any one of paragraphs 1-9, wherein discussion of pedagogy related to said challenges are provided in a separate text window.
¶24. The computer program of any one of paragraph 1-9, wherein the tone of a given challenges' construction is depicted in a graphic or text format.
¶25. An interactive spelling and speech learning system comprising the computer program of any one of paragraph 1-24 played on a computer system comprising:
   a) a central processing unit (CPU) with associated memory and storage capability;
   b) a device for input by a user by touch or mouse control;
   c) speakers for audio output; and

d) a screen for visual display.

Having now fully described the invention, it will be understood by those of skill in the art that the invention may be practiced within a wide and equivalent range of conditions, parameters and the like, without affecting the spirit or scope of the invention or any embodiment thereof.

What is claimed is:

1. An interactive spelling and speech learning system for learning a language comprising a computer program which, when in operation on a computer:
a) generates in a clue area on a computer screen, a first set of tiles, written in a native language wherein:
i) said first set of tiles display alphabet characters, numbers, words, or phrases in said native language;
ii) said first set of tiles are displayed for a predetermined time period, after which they are removed from the clue area;
ii) said first set of tiles provide a challenge which a user of said computer program must match, answer or solve;
b) generates in a selection area on said computer screen, a second set of tiles wherein:
i) said second set of tiles display alphabet characters, numbers, words, or phrases in a tonal or learned language which is different than said native language;
iii) characters from the tonal or learned language displayed on said second set of tiles either alone, or as part of words or phrases, may include diacritical symbols or diacritical symbols may be displayed on separate tiles;
iv) some of the tiles in the second set of tiles are solution tiles which, when selected by a user of said computer program and moved to a test area on said computer screen, will form characters, numbers, words, or phrases in the tonal or learned language that match the alphabet characters, numbers, words, or phrases in the clue area on the computer screen or solve a question provided in the clue area and will result in the computer program indicating that a correct answer has been made;
v) some of the tiles in the second set of tiles may be non-solution tiles, which, when selected by a user of said computer program and moved to a test area on said computer screen, will form characters, numbers, words, or phrases in the tonal or learned language that fail to match the alphabet characters, numbers, words, or phrases in the clue area on the computer screen or will fail to correctly answer a question provided in the clue area and will not result in the computer program indicating that a correct answer has been made;
c) generates said test area on said computer screen, wherein a third set of tiles is displayed, and wherein:
i) said third set of tiles display alphabet characters, numbers, words, or phrases of said tonal or learned language;
ii) said third set of tiles is not displayed in the test area until the user of the program drags tiles from the selection area to the test area;
and wherein:
if a solution tile is dragged from the selection area to the test area it disappears from the selection area;
the computer program sequentially arranges the solution tiles in the test area so that they together form a response that the computer program recognizes as a correct response;
diacritical symbols may be displayed on separate tiles in the selection area whereas, in the test area, they may combine with other tiles to form a tile that contains a combination of characters and diacritical marks;
in response to a correct answer, said computer program produces audio in which the alphabet characters, numbers, words, or phrases of the correct answer are pronounced.

2. The interactive spelling and speech learning system of claim 1, wherein the user selects a tile by using a mouse or touch interface to choose the tile in the selection area and then drag the tile to the response area.

3. The interactive spelling and speech learning system of claim 2, wherein said computer program presents said tiles to said user as part of a game comprising animated objects and/or animated characters.

4. The computer program claim 1, wherein solution tiles and non-solution tiles are chosen by the computer program based on a likelihood that they will be confused with one another due to similarity in pronunciation or the appearance of the alphabet characters, numbers, words, or phrases.

5. The interactive spelling and speech learning system of claim 2, wherein said first set of tiles and said second set of tiles display alphabet characters that may optionally form words or phrases and that may include diacritical symbols or diacritical symbols may be displayed on separate tiles.

6. The interactive spelling and speech learning system of claim 5, wherein at least some tiles generated in said selection area only display diacritical symbols and wherein a tile displaying only a diacritical symbol and a tile displaying only a character may be combined with one another using a mouse or touch interface to form a new tile on which the character is displayed with said diacritical symbol.

7. The interactive spelling and speech learning system of claim 6, wherein said computer program presents said tiles to said user as part of a game comprising animated objects and/or animated characters.

8. The interactive spelling and speech learning system of claim 7, wherein, when a new tile is formed by the combination of a tile with a character and a tile with a diacritical symbol, the new tile assumes a size or shape that is different from either of the tiles combined.

9. The interactive spelling and speech learning system of claim 7, wherein, when a new tile is formed by the combination of a tile with a character and a tile with a diacritical symbol, the new tile assumes a color that is different from either of the tiles combined.

10. The interactive spelling and speech learning system of claim 7, wherein, in response to a new tile being formed by the combination of a tile with a character and a tile with a diacritical symbol, the computer program produces audio in which the newly formed character with the diacritical displayed on the new tile is pronounced.

11. The interactive spelling and speech learning system of claim 6, wherein, in response to a new tile being formed by the combination of a tile displaying a character and a tile displaying a diacritical symbol, the computer program produces audio in which both the character displayed on said new tile is pronounced and the character without the diacritical is separately displayed and pronounced.

12. The interactive spelling and speech learning system of claim 6, wherein solution tiles and non-solution tiles are chosen by the CPU based on a likelihood that they will be confused with one another due to similarity in the pronunciation or the appearance of the characters.

13. The interactive spelling and speech learning system of claim 1, wherein said computer program comprises a graphic user interface (GUI) and provides for:
a) the playback of sounds, the handling of user input, and the retrieval and modification of local program data;
b) the presentation of different subjects and levels of difficulty;
c) the management of GUI animations in a timed, sequential manner; and
d) the scoring and monitoring of the skill level of a user;
wherein said GUI comprises:
i) the clue area which displays text or numbers generated by the CPU and which serves to prompt a user for a response;
ii) the selection area in which characters or symbols are displayed that may be selected by a user;
iii) the test area in which characters selected by the user from the selection area may be placed;
and wherein the movement of characters or symbols by the user from the selection area to the test area results in an awarding of points to a score of the user or an acknowledgement of a correct response if the text or numbers moved match text or numbers predetermined by the CPU.

14. The interactive spelling and speech learning system of claim 13, wherein said GUI further comprises:
a) an information area, which contains special symbols that depict specific notes about challenge word or solution;
b) a score area that displays the score of the user.

15. The interactive spelling and speech learning system of claim 13, wherein said computer program presents said tiles to said user as part of a game comprising animated objects and/or animated characters.

16. The interactive spelling and speech learning system of claim 15, wherein solution tiles and non-solution tiles are chosen by the computer program based on a likelihood that they will be confused with one another due to similarity in pronunciation or the appearance of the alphabet characters, numbers, words, or phrases.

17. The interactive spelling and speech learning system of claim 13, wherein said first set of tiles and said second set of tiles display alphabet characters that may optionally form words or phrases and that may include diacritical symbols or diacritical symbols may be displayed on separate tiles.

18. The interactive spelling and speech learning system of claim 17, wherein at least some tiles generated in said selection area only display diacritical symbols and wherein a tile displaying only a diacritical symbol and a tile displaying only a character may be combined with one another using a mouse or touch interface to form a new tile in which the character and diacritical are displayed together.

19. The interactive spelling and speech learning system of claim 18, wherein solution tiles and non-solution tiles are chosen by the CPU based on a likelihood that they will be confused with one another due to similarity in pronunciation or appearance of the characters.

20. The interactive spelling and speech learning system of claim 19, wherein, in response to a new tile being formed by the combination of a tile with a character and a tile with a diacritical symbol, the computer program produces audio in which the character on said new tile is pronounced.
